(19) United States
(12) Patent Application Publication
(10) Pub. No.: US 2019/0228454 A1
(43) Pub. Date: Jul. 25, 2019

(54) ELECTRONIC APPARATUS AND CONTROLLING METHOD THEREOF

(71) Applicant: Samsung Electronics Co., Ltd., Suwon-si (KR)

(72) Inventor: Jinwang AN, Suwon-si (KR)

(21) Appl. No.: 16/256,523

(22) Filed: Jan. 24, 2019

(30) Foreign Application Priority Data
Jan. 24, 2018 (KR) 10-2018-0008980

(51) Int. Cl. G06Q 30/06; G06F 16/34; G06F 16/335; G06Q 50/00

(52) U.S. Cl. CPC G06Q 30/0631; G06Q 30/0641; G06Q 50/01; G06F 16/337; G06F 16/34

(57) ABSTRACT

An electronic apparatus is provided. The electronic apparatus includes: a communicator comprising communication circuitry; and a processor configured to obtain evaluation information on an item corresponding to a search word and additional information related to the item when the search word is received from an external electronic apparatus through the communicator, and control the communicator to transmit the obtained evaluation information and additional information to the external electronic apparatus through the communicator. The electronic apparatus may obtain evaluation information on an item corresponding to a search word and additional information related to the item using a learned artificial intelligence model according to a deep learning algorithm.

### CROSS-REFERENCE TO RELATED APPLICATION

This application is based on and claims priority under 35 U.S.C. § 119 to Korean Patent Application No. 10-2018-0008980, filed on Jan. 24, 2018, in the Korean Intellectual Property Office, the disclosure of which is incorporated by reference herein in its entirety.

### BACKGROUND

### Field

The disclosure relates to an electronic apparatus and a controlling method thereof, and, for example, to an electronic apparatus for transmitting information related to a search word received from an external electronic apparatus to the external electronic apparatus and a controlling method thereof.

### Description of Related Art

In accordance with the development of Internet technology and communication technology, there is a lot of information online, and users may easily obtain the information through web search. Accordingly, it has recently become common for the users to search for items to get information on the items before purchasing the items.

In particular, people who bought a product at an online shopping mall where the product may be purchased online may leave a review about the product, and people who want to purchase a product may refer to the purchase review left in the online shopping mall before purchasing the product.

In addition, as SNS (Social Network Service) recently becomes popular, the users upload photos and product evaluations about their purchased products to SNS, and as a result, the users may easily access information such as the photos about the products through SNS.

However, as the number of means for obtaining information on the products such as shopping malls, news, and SNS is increasing, the users who are trying to purchase the products have difficulties in selecting and collecting the information. Specifically, there is inconvenience that the users who want to obtain the information on the products have to directly visit several online shopping malls, SNS sites, and portal sites to search for the information. In addition, there is inconvenience that the user must directly summarize or organize the information in order to organize the information obtained from various sites and view the information at a glance.

### SUMMARY

Embodiments of the disclosure address the above disadvantages and other disadvantages not described above.

Various embodiments of the disclosure obtain information on an item corresponding to a search word using the search word input from a terminal apparatus of a user. For example, the disclosure provides an electronic apparatus for obtaining evaluation information and additional information on a product corresponding to a search word using an artificial intelligence model and transmitting the evaluation information and the additional information to a terminal apparatus, and a controlling method thereof.

According to an embodiment of the disclosure, an electronic apparatus includes: a communicator comprising communication circuitry; and a processor configured to obtain evaluation information on an item corresponding to a search word and additional information related to the item based on the search word being received from an external electronic apparatus through the communicator, and control the communicator to transmit the obtained evaluation information and additional information to the external electronic apparatus through the communicator, wherein the additional information includes at least one of: information on a news web page including a specific word among news web pages for a category to which the item belongs, and information on a user using the item among users of a social network service (SNS) to which a user of the external electronic apparatus subscribes.

The processor may classify evaluation information provided from a web page into positive evaluation information and negative evaluation information on the item by analyzing the web page providing the evaluation information on the item through a learned artificial intelligence model to classify the evaluation information into the positive evaluation information and the negative evaluation information, and transmit the positive evaluation information and the negative evaluation information to the external electronic apparatus.

The processor may search for a plurality of news web pages providing news for the category to which the item belongs, obtain a news web page including the specific word among the plurality of news web pages through a learned artificial intelligence model to identify whether or not the specific word is included, and transmit information on the obtained news web page to the external electronic apparatus.

The specific word may be a word indicating damage that occurs to a consumer using at least one item belonging to the same category as the category to which the item belongs.

The processor may search for a post uploaded to a server providing the SNS by a user having a relationship with the user of the external electronic apparatus in the SNS in the web page related to the item, and obtain information on a user who creates the searched post.

The information on the user may include identification (ID) of the user who creates the searched post.

According to another embodiment of the disclosure, a controlling method of an electronic apparatus includes: receiving a search word from an external electronic apparatus; obtaining evaluation information on an item corresponding to the search word and additional information related to the item; and transmitting the obtained evaluation information and additional information to the external electronic apparatus, wherein the additional information includes at least one of: information on a news web page including a specific word among news web pages for a category to which the item belongs, and information on a user using the item among users of a social network service (SNS) to which a user of the external electronic apparatus subscribes.

The obtaining of the evaluation information may include classifying evaluation information provided from a web page into positive evaluation information and negative evaluation information on the item by analyzing the web page providing the evaluation information on the item through a learned artificial intelligence model to classify the evaluation information into the positive evaluation information and the negative evaluation information, and the transmitting of the evaluation information to the external electronic apparatus may include transmitting the positive evaluation information and the negative evaluation information to the external electronic apparatus.

The obtaining of the additional information may include searching for a plurality of news web pages providing news for the category to which the item belongs, and obtaining a news web page including the specific word among the plurality of news web pages through a learned artificial intelligence model to identify whether or not the specific word is included.

The specific word may be a word indicating damage that occurs to a consumer using at least one item belonging to the same category as the category to which the item belongs.

The obtaining of the additional information may include searching for a post uploaded on a server providing the SNS by a user having a relationship with the user of the external electronic apparatus in the SNS in the web page related to the item, and obtaining information on a user who creates the searched post.

The information on the user may include identification (ID) of the user who creates the searched post.

According to the various example embodiments, because the evaluation information and the additional information about the item related to the search word are transmitted to the external electronic apparatus of the user, the user who wants to search for a specific item does not need to visit a plurality of online shopping malls and web pages to collect information related to the item. For example, the disclosure provides the information having high accuracy about the item using the artificial intelligence model. Accordingly, the convenience of the user is increased because the user may obtain the information having high accuracy at a time.

### BRIEF DESCRIPTION OF THE DRAWINGS

The above and/or other aspects, features and advantages of certain embodiments of the present disclosure will be more apparent from the following detailed disclosure, taken in conjunction with the accompanying drawings, in which:

FIG. 1 is a diagram illustrating an example electronic apparatus and an external electronic apparatus according to an embodiment of the disclosure;

FIG. 2 is a sequence diagram illustrating an example operation between the electronic apparatus and the external electronic apparatus according to an embodiment of the disclosure;

FIGS. 3A and 3B are block diagrams illustrating example configurations of the external electronic apparatus according to an embodiment of the disclosure;

FIG. 4 is a diagram illustrating an example software configuration stored in a storage of the external electronic apparatus according to an embodiment of the disclosure;

FIG. 5 is a block diagram illustrating an example configuration of the electronic apparatus according to an embodiment of the disclosure;

FIG. 6 is a diagram illustrating an example software configuration stored in a storage of the electronic apparatus according to an embodiment of the disclosure;

FIG. 7 is a flowchart illustrating an example process of obtaining evaluation information according to an embodiment of the disclosure;

FIGS. 8 and 9 are flowcharts illustrating example processes of obtaining additional information according to an embodiment of the disclosure;

FIG. 10 is a diagram illustrating an example of evaluation information and additional information displayed on an external electronic apparatus according to an embodiment of the disclosure;

FIG. 11 is a flowchart illustrating an example process of obtaining added evaluation information or additional information by the electronic apparatus according to an embodiment of the disclosure; and

FIG. 12 is a flowchart illustrating an example method of controlling an electronic apparatus according to an embodiment of the disclosure.

### DETAILED DESCRIPTION

As the terms used in the disclosure, general terms which are currently used as widely as possible are selected but may be varied depending on an intention of those skilled in the art, a practice, an emergence of new technologies, and the like. In addition, there are terms which may be arbitrarily, and in this case, a meaning thereof will be described in the disclosure corresponding to the terms. Therefore, the terms used in the disclosure should be defined based on the meanings of the terms and the contents and general knowledge throughout the disclosure, not simple names of the terms.

In the disclosure, the terms first, second, etc. may be used to refer to various components. These terms are not used to limit the order, characteristics, and number of components, and are used only for the purpose of distinguishing the components from each other.

The terms used in the disclosure are used to describe the specific embodiments, and are not intended to limit the scope of the disclosure. As used herein, the singular forms are intended to include plural forms as well, unless the context clearly indicates otherwise. Throughout the disclosure, unless explicitly described to the contrary, “comprising” or “configuring” any components will be understood to imply the inclusion of other components rather than the exclusion of any other components.

In addition, the terms “-er”, “module”, and the like described in the disclosure may refer, for example, to units for processing at least one function or operation, and can be implemented by hardware, software, or any combinations thereof. In addition, a plurality of “-ers” or a plurality of “modules” may be integrated into at least one module and may be implemented in at least one processor (not illustrated), except for a “-er” and “module” in which they need to be implemented in specific hardware.

Hereinafter, various example embodiments of the disclosure will be described in greater detail with reference to the accompanying drawings. However, the disclosure may be implemented in various different ways, and is not limited to the embodiments described in the disclosure. In the accompanying drawings, portions unrelated to the description may be be omitted, and similar reference numerals may be used to describe similar portions throughout the disclosure.

Hereinafter, various example embodiments of the disclosure will be described in greater detail with reference to the accompanying drawings.

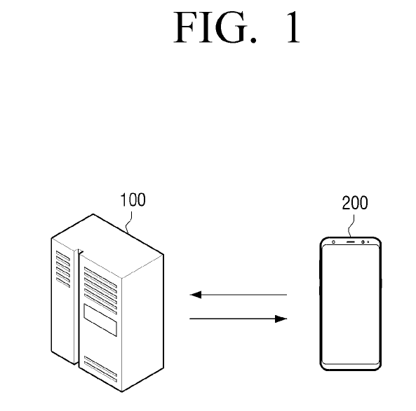

FIG. 1 is a diagram illustrating an example electronic apparatus and an external electronic apparatus according to an embodiment of the disclosure.

An electronic apparatus 100 may perform communication with an external electronic apparatus 200. The electronic apparatus 100 may receive a search word from the external electronic apparatus 200. The search word may, for example, include a product name or an item name that a user of the external electronic apparatus 200 desires to search.

The electronic apparatus 100 may perform an information search using the search word received from the external electronic apparatus 200. The electronic apparatus 100 may search for web pages on the Internet, and for this purpose, the electronic apparatus 100 may utilize a learned artificial intelligence model.

The electronic apparatus 100, a network apparatus, may be an external network apparatus such as, for example and without limitation, a cloud server, a local network apparatus such as a router, a home server, or the like. The electronic apparatus 100 may be implemented, for example, and without limitation, as an embedded apparatus and may, for example and without limitation, be embedded in a TV, a refrigerator, or the like rather than an apparatus having a separate independent body.

The external electronic apparatus 200 may be a user terminal apparatus, and may receive the search word including a product name or an item name from the user and transmit the search word to the electronic apparatus 100.

In addition, the external electronic apparatus 200 may receive information corresponding to the search word obtained by the electronic apparatus 100 from the electronic apparatus 100 and display the information.

In FIG. 1, as the external electronic apparatus 200, a smartphone is illustrated, but the external electronic apparatus 200 is not limited thereto. The external electronic apparatus 200 may also be implemented for example, and without limitation, as a PC, a tablet PC, a notebook, a TV, or the like.

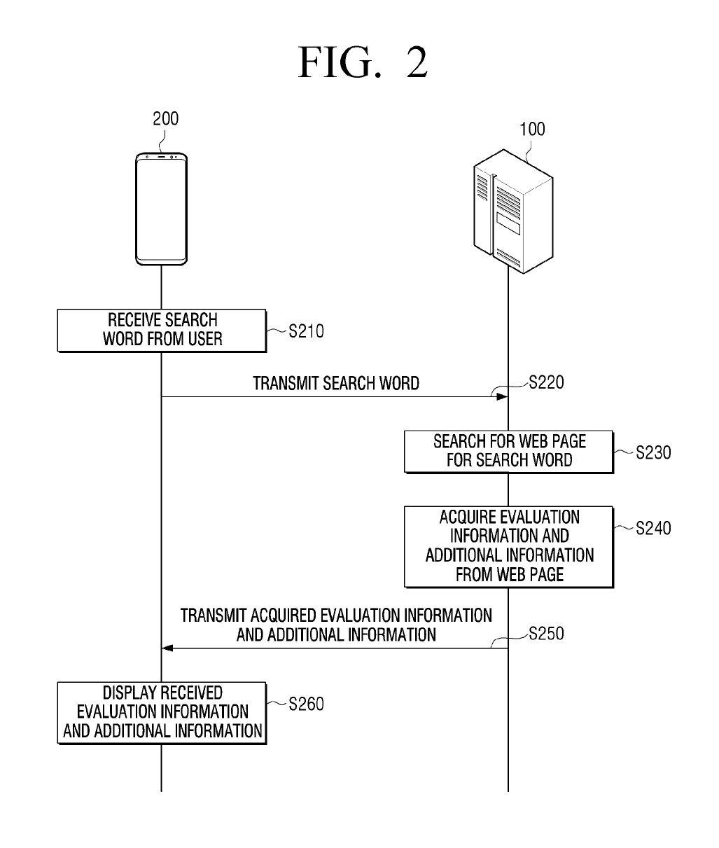

FIG. 2 is a sequence diagram illustrating an example operation between the electronic apparatus and the external electronic apparatus according to an embodiment of the disclosure.

The external electronic apparatus 200 may receive the search word from the user (S210). The search word may refer, for example, to a word to be searched by the user, and may include, for example, and without limitation, a product name, an item name, or the like.

The user may input the search word in the form of a sentence, not only in the form of a word. For example, the user may, for example, also input the sentences “please search for car A” and “How is the performance of the notebook B” to the external electronic apparatus 200. The external electronic apparatus 200 may analyze the sentences input by the user using a natural language processing module and may catch the search word from the sentences inputted by the user.

The user may also input a text corresponding to the search word to the external electronic apparatus 200 and may also input voice to the external electronic apparatus 200. In case that the user inputs the search word through the voice, the external electronic apparatus 200 may convert the voice of the user into an electrical signal using a voice recognition module. For example, the external electronic apparatus 200 may convert the voice of the user into the electrical signal by extracting only the voice of the user even in a situation in which there is external noise.

In addition, the user may also input an image corresponding to the search word. For example, the image may also be an image prestored in a storage (not illustrated) of the external electronic apparatus 200, and may also be an image captured by a camera of the external electronic apparatus.

After receiving the search word from the user, the external electronic apparatus 200 transmits the search word to the electronic apparatus 100 (S220).

The electronic apparatus 100 receives the search word from the external electronic apparatus 200, and searches for a web page for the received search word (S230). The electronic apparatus 100 may search for a plurality of web pages including the search word and may obtain a keyword associated with the search word from the plurality of web pages.

In addition, the electronic apparatus 100 may also obtain information on a product corresponding to the search word from the plurality of web pages (S240).

The electronic apparatus 100 may obtain evaluation information on the item on the web page associated with the item corresponding to the search word using an artificial intelligence model. The evaluation information on the item may include, for example, and without limitation, an advantage and a disadvantage for the item, a rating for the item in the shopping mall that sells the item, or the like.

In addition, the electronic apparatus 100 may also obtain consumer damage news associated with the item corresponding to the search word using the artificial intelligence model. In addition, the electronic apparatus 100 may also obtain information on SNS user using the item corresponding to the search word through a web page search.

In the disclosure, web page information including the information on the item corresponding to the search word or the information on the SNS user using the item may, for example, be referred to as additional information. For example, the additional information may include, for example, and without limitation, at least one of information on a news web page including a specific word among news web pages for a category to which the item belongs, information on a user who uses the item among the users of the SNS to which the user of the electronic apparatus subscribes, or the like.

The electronic apparatus 100 may transmit the evaluation information and the additional information obtained as a result of the web page search to the external electronic apparatus 200 (S250).

Accordingly, the external electronic apparatus 200 may display the received evaluation information and additional information on a display screen (S260). The external electronic apparatus 200 may display a summary page of the received evaluation information and additional information on the display screen. Accordingly, the user may view the evaluation information and the additional information on the product corresponding to the search word on one screen.

The user of the external electronic apparatus 200 may obtain various evaluation information and additional information through one input of the search word.

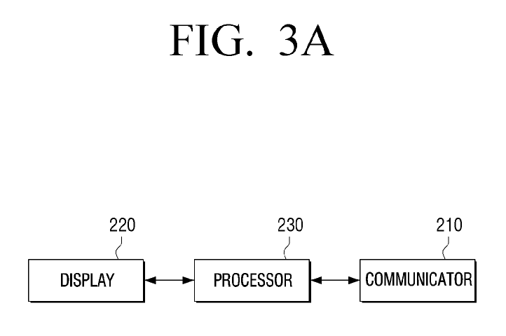

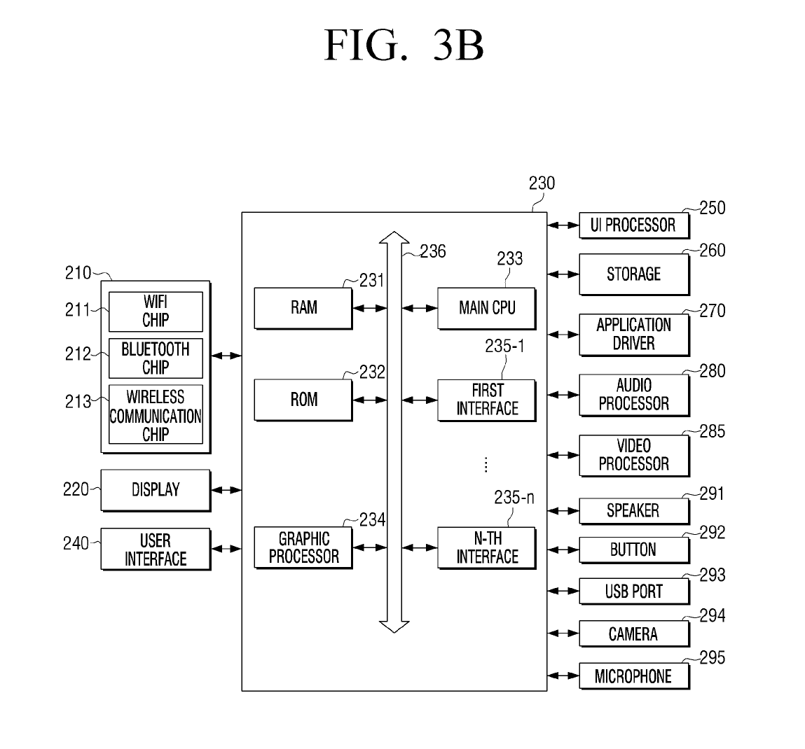

FIGS. 3A and 3B are block diagrams illustrating example configurations of the external electronic apparatus. As illustrated in FIG. 3A, the external electronic apparatus 200 may include a display 220, a communicator (e.g., including communication circuitry) 210, and a processor (e.g., including processing circuitry) 230.

The display 220 may be implemented, for example, and without limitation, as a plasma display panel (PDP), a liquid crystal display (LCD), an organic light emitting diodes (OLED), or the like, to receive the evaluation information and the additional information received from the electronic apparatus 100, but is not limited thereto.

In addition, the display 220 may be implemented in the form of a touchscreen, and in some cases, the display 220 may also be implemented, for example, and without limitation, as a flexible display, a transparent display, or the like.

The communicator 210 may include various communication circuitry and performs communication with the electronic apparatus 100. The communicator 210 may perform the communication with the electronic apparatus 100 using various communication schemes, such as, for example, and without limitation, wired/wireless LAN, WAN, Ethernet, Bluetooth, Zigbee, Wi-Fi, power line communication (PLC), or the like.

The processor 230 may include various processing circuitry and controls an overall operation of the external electronic apparatus 200. The processor 230 may include, for example, and without limitation, one or more of a central processing unit (CPU), a controller, an application processor (AP), a communication processor (CP), an ARM processor, or the like.

When the user inputs the search word to the external electronic apparatus 200, the processor 230 may transmit the search word to the electronic apparatus 100. In addition, when the evaluation information and the additional information are received from the electronic apparatus 100, the processor 230 may summarize the evaluation information and the additional information and display a summary page.

The external electronic apparatus 200 may include, for example, and without limitation, a microphone (not illustrated) and a camera (not illustrated) to receive a user input, and may also include a variety of programs for driving the external electronic apparatus 200 or a storage (not illustrated) for storing an application.

FIG. 3B is a block diagram illustrating an example configuration of the external electronic apparatus 200 illustrated in FIG. 3A. The external electronic apparatus 200 includes the communicator (e.g., including communication circuitry) 210, the display 220, the processor (e.g., including processing circuitry) 230, a user interface (UI) 240, a UI processor (e.g., including UI processing circuitry and/or program elements) 250, a storage 260, an application driver 270, an audio processor (e.g., including audio processing circuitry) 280, a video processor (e.g., including video processing circuitry) 285, a button 292, a USB port 293, a camera 294, a microphone 295, and a speaker 291. A detailed description of the components overlapped with the components illustrated in FIG. 3A among the components illustrated in FIG. 3B may not be repeated here.

The communicator 210 may include various communication circuitry for performing communication with the electronic apparatus 100 according to various types of communication schemes. The communicator 210 may include various communication chips including various communication circuitry, such as, for example, and without limitation, a Wi-Fi chip 211, a Bluetooth chip 212, a wireless communication chip 213, and the like.

The Wi-Fi chip 211 and the Bluetooth chip 212 perform the communication in a Wi-Fi scheme and a Bluetooth scheme, respectively. The wireless communication chip 213 may refer, for example, to a chip that performs communication according to various communication standards such as IEEE, ZigBee, 3^{rd} generation (3G), 3^{rd} generation partnership project (3GPP), Long Term Evolution (LTE), and the like. In addition, the communicator 210 may further include a near field communication (NFC) chip that operates in a NFC scheme that uses a frequency band of 13.56 MHz among various RF-ID frequency bands such as 135 kHz, 13.56 MHz, 433 MHz, 860 to 960 MHz, 2.45 GHz, and the like.

An operation of the processor 230 may be performed by a program stored in the storage 260. The storage 260 may store various data such as an operating system (O/S) software module for driving the user terminal apparatus 200, a variety of applications, a variety of data input or set during an application execution, the contents, and the like.

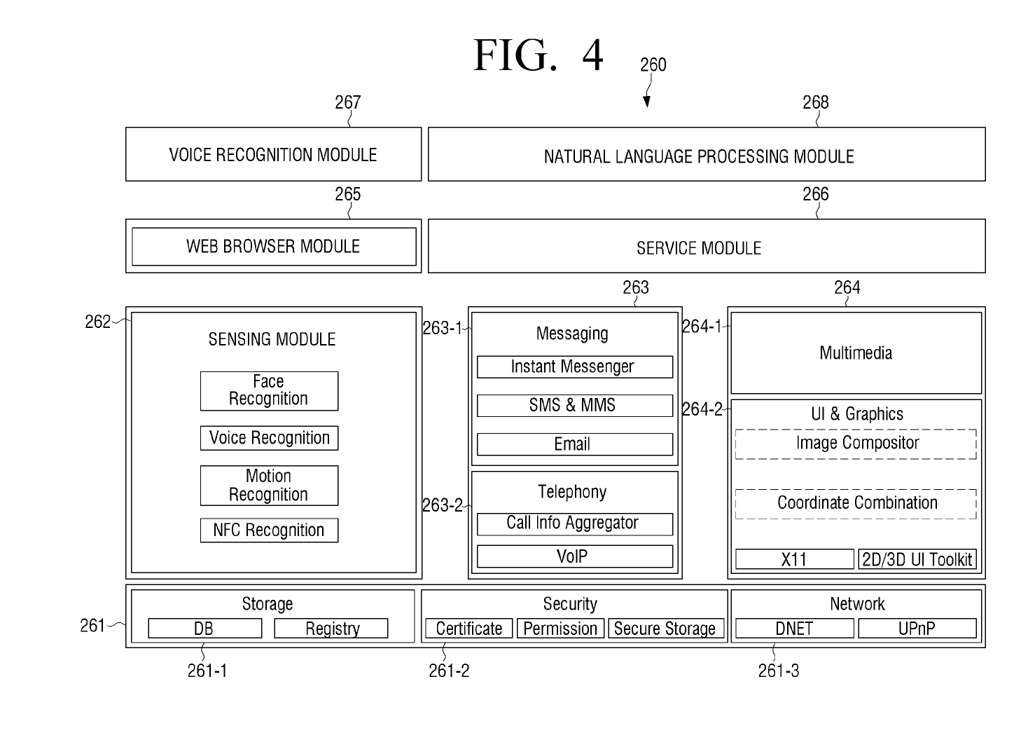

In addition, various software modules stored in the storage 260 will be described below with reference to FIG. 4.

The user interface 240, which may refer, for example, to an input for receiving the search word from the user and transmitting the search word to the processor 230, may be implemented, for example, and without limitation, as an input panel. The input panel may be formed, for example, and without limitation, in a touch pad type, a key pad type, touch screen type including a variety of function keys, number keys, special keys, letter keys, and the like.

When the user inputs the text as the search word, the user interface may be used.

The UI processor 250 may include various processing circuitry and/or program elements and generate various types of GUIs.

In addition, the UI processor 250 may process/generate various UI screens in the form of 2D or 3D. The UI screen may be a screen for inputting the search word or a screen for displaying the evaluation information and the additional information. The UI screen may be a menu screen, a screen for displaying a warning phrase, characters or figures such as a time or a channel number, and the like.

In addition, the UI processor 250 may perform operations such as, for example, and without limitation, 2D/3D conversion of UI elements, transparency, color, size, shape, position adjustment thereof, highlighting thereof, animation effect thereof, or the like.

The storage 260, may refer, for example, to a storing medium in which a variety of programs necessary to operate the user terminal apparatus 200 are stored, may be implemented, for example, and without limitation, by a memory, a hard disk drive (HDD), and the like. For example, the storage 260 may include a read only memory (ROM) for storing a program for executing the operation of the processor 230, a random access memory (RAM) for temporarily storing data according to the operation execution of the processor 230, and the like. In addition, the storage 260 may further include an electrically erasable and programmable ROM (EEPROM) for storing a variety of reference data.

The storage 260 may also store an application associated with a product search.

The application driver 270 may include various driver circuitry and/or program elements and may serve to drive and execute an application that may be provided by the user terminal apparatus 200 itself. The application may, for example, be a self-executable application program that may include a variety of multimedia contents. The term ‘multimedia contents’ includes, for example, and without limitation, text, audio, still image, animation, video, and interactivity content, electronic program guide (EPG) content from a content provider, electronic messages received from the users, information about a current event, and the like, but are not limited thereto.

The audio processor 280 may include various audio processing circuitry and/or program elements that process audio data. The audio processor 280 may perform various processes such as, for example, and without limitation, decoding, amplification, noise filtration, or the like, for the audio data.

The video processor 285 may include various video processing circuitry and/or program elements that perform a processing for video data. The video processor 285 may perform various image processes such as, for example, and without limitation, decoding, scaling, noise filtration, frame rate conversion, resolution conversion, or the like, for the video data.

The speaker 291 may, for example, output a variety of alarm sounds or voice messages as well as a variety of audio data processed by the audio processor 280.

The button 292 may include, for example, various types of buttons such as, for example, and without limitation, a mechanical button, a touch pad, a wheel, or the like, formed in an arbitrary region such as a front part, a side part, a rear part, or the like of the exterior of a body of the user terminal apparatus 200. For example, a button for turning on/off the power of the user terminal apparatus 200 may be provided.

The USB port 293 may perform communication with a variety of external apparatuses through a USB cable, or perform charging or the like.

The camera 294 may capture a still image or a moving image under the control of the user. The camera 294 may be implemented by a plurality of cameras such as a front camera and a rear camera.

The microphone 295 may receive and convert the user voice or other sounds into the audio data. The processor 230 may use the user voice received through the microphone 295 during a call process or convert the user voice into the audio data to store it in storage 260.

In case that the camera 294 and the microphone 295 are provided, the processor 230 may also perform a control operation according to the user voice input through the microphone 295 or a user motion recognized by the camera 294. For example, the user terminal apparatus 200 may be operated in a motion control mode or a voice control mode. In case that the user terminal apparatus 200 is operated in the motion control mode, the processor 230 activates the camera 294 to capture the user and tracks a change in the motion of the user to perform a control operation corresponding to the change in the motion. In case that the user terminal apparatus 200 is operated in the voice control mode, the processor 230 may analyze the user voice input through the microphone and may also be operated in a voice recognition mode that performs a control operation according to the analyzed user voice.

In addition, the external electronic apparatus may further include various external input ports for connection with various external terminals such as, for example, and without limitation, a headset, a mouse, a LAN, and the like.

The processor 230 may include various processing circuitry and control an overall operation of the user terminal apparatus 200 using a variety of programs stored in the storage 260.

For example, the processor 230 may execute an application stored in the storage 260 and configure and display an execution screen and may reproduce various contents stored in the storage 260. In addition, the processor 230 may also perform communication with external devices through the communicator 210.

The processor 230 may include, for example, a random access memory (RAM) 231, a read only memory (ROM) 232, a main central processing unit (CPU) 233, a graphic processor 234, first to n-th interfaces 235-1 to 235-n, and a bus 236.

The RAM 231, the ROM 232, the main CPU 233, the graphic processor 234, the first to n-th interfaces 235-1 to 235-n, and the like may be connected to each other through the bus 236.

The first to n-th interfaces 235-1 to 235-n are connected to the variety of components described above. One of the interfaces may be a network interface connected to an external apparatus via a network.

The main CPU 233 accesses the storage 260 and performs a booting operation using an operating system (O/S) stored in the storage 260. In addition, the main CPU 233 performs various operations using a variety of programs, contents, data, and the like stored in the storage 260.

The ROM 232 stores a set of instructions for booting a system, and the like. When a turn-on command is input to the main CPU 233 to supply the power to the main CPU 233, the main CPU 233 copies the O/S stored in the storage 260 in the RAM 231 according to the instructions stored in the ROM 232 and executes the O/S to boot the system. When the booting of the system is completed, the main CPU 233 copies a variety of application programs stored in the storage 260 in the RAM 231 and executes the application programs copied in the RAM 231 to perform a variety of operations.

The graphic processor 234 generates a screen including various objects such as an icon, an image, a text, and the like using a calculator (not illustrated) and a renderer (not illustrated). The calculator calculates attribute values such as coordinate values, shapes, sizes, colors, and the like in which the respective objects are to be displayed, according to a layout of the screen using a received control command. The renderer generates the screen of various layouts including the objects based on the attribute values calculated by the calculator. The screen generated by the renderer is displayed in a display region of the display 220.

Although not illustrated in the drawings, the user terminal apparatus 200 may further include a detector (not illustrated).

The detector (not illustrated) may include various circuitry and detect various manipulations such as touch, rotation, tilt, pressure, and access to the user terminal apparatus 200. For example, the detector (not illustrated) may include a touch sensor that detects the touch. The touch sensor may be implemented in a capacitive type or a resistive type. The capacitive type may refer, for example, to a scheme calculating a touch coordinate by detecting micro-electricity exited into a body of the user when a portion of the body of the user touches a surface of the display 220, using a dielectric coated on the surface of the display 220. The resistive type may refer, for example, to a scheme including two electrode plates and calculating the touch coordinate by detecting that upper and lower plates of a touched point are in contact with each other to allow a current to flow, when the user touches the screen. As described above, the touch sensor may be implemented in various forms. In addition, the detector may further include a geomagnetic sensor for detecting a rotation state and a moving direction of the user terminal apparatus 200, an acceleration sensor for detecting a tilt degree of the user terminal apparatus 200, and the like.

FIG. 3B illustrates an example of the components included in the user terminal apparatus 200, and according to the embodiment, some of the components illustrated in FIG. 3B may be omitted or modified, and other components may be further added. For example, and without limitation, the user terminal apparatus 200 may further include a global positioning system (GPS) receiver (not illustrated) for receiving a GPS signal from a GPS satellite to calculate a current position of the user terminal apparatus 200, a digital multimedia broadcasting (DMB) receiver (not illustrated) for receiving a DMB signal to process the DMB signal, and the like.

FIG. 4 is a diagram illustrating an example software configuration stored in a storage of the external electronic apparatus according to an embodiment.

Referring to FIG. 4, the storage 260 may store software including various program elements, such as, for example, and without limitation, a base module 261, a sensing module 262, a communication module 263, a presentation module 264, a web browser module 265, a service module 266, a voice recognition module 267 and a natural language processing module 268.

The base module 261 may refer, for example, to a basic module processing signals transferred from the respective hardware included in the external electronic apparatus 200 and transferring the processed signals to a higher layer module. The base module 261 includes a storage module 261-1, a security module 261-2, a network module 261-3, and the like. The storage module 261-1 may refer, for example, to a program module managing a database (DB) or a registry. The main CPU 233 may access a database in the storage 260 using the storage module 261-1 to thereby read out a variety of data. The security module 261-2 may refer, for example, to a program module supporting certification, request permission, secure storage, and the like for hardware, and the network module 261-3, which may refer, for example, to a module for supporting a network connection, includes a DNET module, an UPnP module, and the like.

The sensing module 262 may refer, for example, to a module collecting information from a variety of sensors, and analyzing and managing the collected information. The sensing module 262 may also include a face recognition module, a voice recognition module, a motion recognition module, an NFC recognition module, and the like.

The communication module 263 may refer, for example, to a module for performing communication with the outside. The communication module 263 may include a messaging module 263-1 such as a messenger program, a short message service (SMS) & multimedia message service (MMS) program, an e-mail program, or the like, and a telephony module 263-2 including, for example, a call info aggregator program module, a VoIP module, and the like.

The presentation module 264 may refer, for example, to a module for configuring a display screen. The presentation module 264 may include a multimedia module 264-1 for reproducing and outputting multimedia contents and a UI rendering module 264-2 performing a UI and graphic processing. The multimedia module 264-1 may include a player module, a camcorder module, a sound processing module, and the like. Therefore, the multimedia module 264-1 reproduces a variety of multimedia contents to perform an operation of generating and reproducing the screen and the sound. The UI rendering module 264-2 may include an image compositor module combining images, a coordinate combination module combining and generating coordinates on the screen which the image is to be displayed, an X11 module receiving a variety of events from hardware, a 2D/3D UI toolkit providing a tool for configuring a 2D or 3D type of UI, and the like.

The web browser module 265 may refer, for example, to a module performing a web browsing to access a web server. The web browser module 265 may include various modules such as a web view module configuring a web page, a download agent module performing a download, a bookmark module, a webkit module, and the like.

The service module 266 may refer, for example, to a module including a variety of applications for providing various services. Specifically, the service module 266 may include various program modules such as a navigation program, a content reproduction program, a game program, an e-book program, a calendar program, an alarm management program, and other widgets.

The voice recognition module 267 may refer, for example, to a module that recognizes the voice of the user and converts an analog voice signal into a digital electronic signal. For example, the voice recognition module may include an analog-to-digital conversion (ADC) module for converting an analog signal input from the microphone into a digital signal, an energy determination module, a noise removal module, and the like.

The natural language processing module 268, may refer, for example, to a module for analyzing a structure of a sentence so that the external electronic apparatus 200 processes the sentence inputted by the user. By providing the natural language processing module, the user may input the search word in the form of a sentence.

Although FIG. 4 illustrates various program modules, the various program modules illustrated in FIG. 4 may be partially omitted, modified, or added depending on the type and characteristics of the external electronic apparatus 200. For example, the program modules may be implemented in the form that further includes a location-based module supporting location-based services in cooperation with hardware such as the GPS chip.

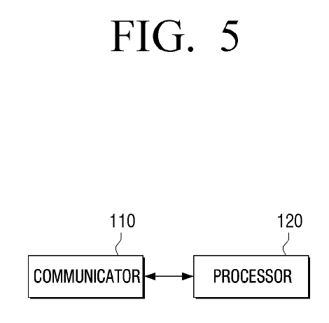

FIG. 5 is a block diagram illustrating an example configuration of the electronic apparatus according to an embodiment.

As illustrated in FIG. 5, the electronic apparatus 100 includes the communicator (e.g., including communication circuitry) 110 and the processor (e.g., including processing circuitry) 120.

The communicator 110 may include various communication circuitry and perform communication with the external electronic apparatus 200 under the control of the processor 120. For example, the communicator 110 may receive the search word from the external electronic apparatus 200, and transmit the evaluation information and the additional information on the product corresponding to the search word to the external electronic apparatus 200.

To this end, the communicator 110 may include various communication modules including various communication circuitry, such as, for example, and without limitation, a wired communication module, a local area wireless communication module (not illustrated), a wireless communication module (not illustrated), and the like. The local area wireless communication module may refer, for example, to a module for performing communication with the external electronic apparatus 200 located at a local area according to a local area wireless communication scheme such as, for example, and without limitation, Bluetooth (BT), Bluetooth low energy (BLE), ZigBee schemes, or the like. In addition, the wireless communication module is a module connected to an external network according to a wireless communication protocol such as, for example, and without limitation, WiFi, IEEE, or the like, to perform communication with the external electronic apparatus 200. In addition, the wireless communication module may further include a mobile communication module connected to a mobile communication network according to various mobile communication standards such as, for example, and without limitation, 3^{rd} generation (3G), 3^{rd} generation partnership project (3GPP), Long Term Evolution (LTE), LTE advanced (LTE-A), 5th generation (5G) networks, and the like to perform communication.

The processor 120 may include various processing circuitry and controls an overall operation of the electronic apparatus 100. The processor 120 may, for example, be a component for controlling the overall operation of the electronic apparatus 100 and a signal flow between internal components of the electronic apparatus 100, and processing data. For example, the processor 120 may control components of a variety of hardware or software included in the electronic apparatus 100, and perform a variety of data processing and calculation. In addition, the processor 120 may load and process instructions or data received from at least one of the other components into memory and store various data in a non-volatile memory. The processor 120 may be implemented, for example, and without limitation, as a dedicated processor (e.g., an embedded processor) for performing a corresponding operation, a generic-purpose processor (e.g., a CPU or an application processor) that may perform the corresponding operations by executing one or more software programs stored in a memory device, or the like.

The processor 120 may, for example, receive the search word from the external electronic apparatus 200 through the communicator 110. The processor 120 may obtain the evaluation information on the item corresponding to the search word and the additional information associated with the item, and transmit the obtained evaluation information and additional information to the external electronic apparatus through the communicator 110.

In order to obtain the evaluation information and the additional information, the processor 120 may, for example, use a learned artificial intelligence model, related software, and the like which are stored in the storage (not illustrated). The processor 120 may use, for example, and without limitation, a deep learning module, a natural language processing module, a web search engine module, or the like, which may be stored in the storage (not illustrated).

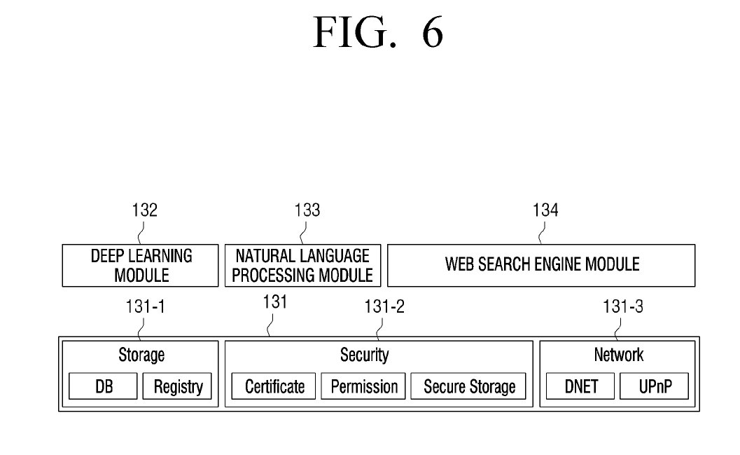

FIG. 6 is a diagram illustrating an example software configuration stored in a storage of the electronic apparatus according to an embodiment.

The storage (not illustrated) may store software including, for example, and without limitation, various modules including various program elements, such as, for example, and without limitation, a base module 131, a deep learning module 132, a natural language processing module 133, and a web search engine module 134.

The description of the base module 131 (including elements 131-1, 131-2 and 131-3) is the same as or similar to that of the base module 261 (including elements 261-1, 261-2 and 261-3) stored in the storage of the external electronic apparatus 200 of FIG. 4, and thus a description thereof will not be repeated here.

The deep learning module 132 may refer, for example, to a module for machine learning of the electronic apparatus 100. The deep learning module 132 may include a learned artificial intelligence model. The electronic apparatus 100 may determine a positive or negative representation of a web page by using the deep learning module 132. Specifically, the deep learning module 132 may determine whether a sentence in the web page is the positive or negative representation by receiving the sentence of the web page analyzed by the natural language processing module 133.

The natural language processing module 133 may refer, for example, to a module of analyzing the sentence in the web page. The electronic apparatus 100 may analyze a sentence structure in the web page using the natural language processing module 133.

The web search engine module 134 may refer, for example, to a module for searching for web pages on Internet.

In addition, the storage (not illustrated) may include, for example, and without limitation, a deep learning storage (not illustrated) for storing data required for deep learning, a web search processing storage (not illustrated) for storing data for web search, a keyword processing storage (not illustrated) for storing a keyword of a web page, or the like.

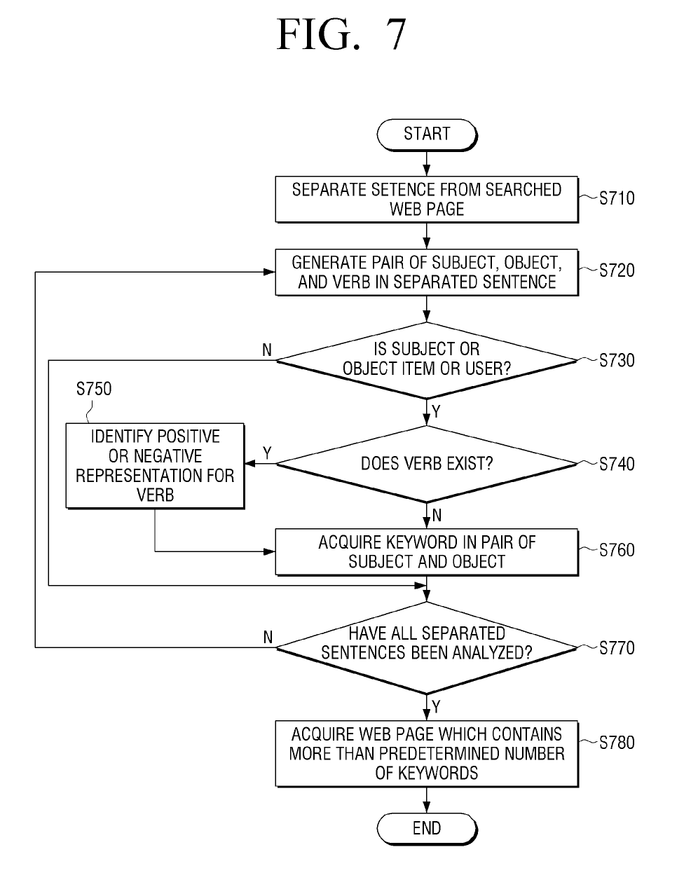

FIG. 7 is a flowchart illustrating an example process of obtaining evaluation information according to an embodiment of the disclosure. FIG. 7 is a diagram for illustrating an example operation of obtaining the evaluation information, which may, for example, be a portion of step S240 of FIG. 2.

The processor 120 may separate the sentence from a plurality of searched web pages (S710). For example, the processor 120 may separate the web pages including a plurality of sentences into units of sentences. The processor 120 may use the natural language processing module stored in the storage (not illustrated).

The processor 120 may classify a subject, an object, and a verb included in the separated sentence, and generate a pair having the subject, the object, and the verb as components (S720). The processor 120 may detect a structure of the sentence using the natural language processing module and generate a pair of subject, object, and verb included in the sentence.

For example, in case of a sentence “the child likes the bicycle”, the process 120 may determine that the subject is ‘child’, the object is ‘bicycle’, and the verb is ‘like’, and generate a pair of (child, bicycle, like).

The sentence of the web page may not include any one of the subject, the object, and the verb. In this case, the processor 120 may also generate a pair having only the subject, the object, and the verb existing in the sentence as the components.

The plurality of sentences configuring the web page may be classified into a sentence including information on the item and a sentence that does not include the information on the item. In case of the sentence including the information on the item, a word related to the item or a word related to the user may be placed in the subject or object position of the sentence.

The processor 120 may determine whether the word used as the subject or the object in the generated pair is the word related to the item or the word related to the user (S730) to determine whether or not the sentence including the generated pair is the sentence including the information on the item. To this end, the learned artificial intelligence model including the natural language processing module may be used.

In case that the words used as the subject and the object are not the word related to the item or the user, that is, the subject and the object in the generated pair are not the word related to the item or the user, the processor 120 may not determine the sentence including the generated pair.

For example, in case of a sentence “saw advertisement and made a purchase”, two (subject, object, verb) pairs of (, advertisement, saw) and (, purchase, made) may be generated, in which there is no word used as the subject, and the words ‘advertisement’ and ‘purchase’ which are not related to the item or the user are used as the object.

In this case, the processor 120 may terminate the analysis of the sentence including the generated pair, and generate a pair (of subject, object, and verb) for a next sentence to perform an analysis.

The processor 120 may analyze a web page providing the evaluation information on the item corresponding to the search word through the learned artificial intelligence model so as to classify the evaluation information into positive evaluation information and negative evaluation information.

To classify the evaluation information into the positive evaluation information and the negative evaluation information, the electronic apparatus 100 may learn a positive or negative expression of the item by using a lot of information on the item before receiving the search word, and may derive the learned artificial intelligence model through a lot of learning. The electronic apparatus 100 may be equipped with a pre-learned artificial intelligence model without performing self learning.

The processor 120 may determine whether the verb exists in the pair generated using the learned artificial intelligence model (S740) and may identify the positive or negative representation for the verb when the verb exists (S750).

The processor 120 may also assign a score according to the representation of the sentence. For example, the processor 120 may assign a positive score to a verb of a positive representation, a negative score to a verb of a negative representation, and a score of 0 if the representation is neither positive nor negative.

In addition, the processor 120 may also assign scores differently taking into account an adverbial representation in the sentence including the corresponding the verb even in the case of the same positive representation. For example, in case that the generated pair is (child, bicycle, like), and an original sentence generating the pair of (child, bicycle, like) is “the child very likes the bicycle”, the processor may assign a higher score to the sentence “the child very likes the bicycle” than the sentence “the child likes the bicycle” by taking into account the adverbial representation “very”.

After identifying the positive or negative representation using the verb, the processor 120 may obtain the keyword using the subject and the object (S760). For example, because the words used in the subject and object in step S730 exclude the pair of (subject, object, and verb) that is not the word related to the item or the user, the word used as the subject or the object in the pair of (subject, object, verb) determined in step S760 may be the word related to the item or the user.

The processor 120 may set each of the words used as the subject or object in the generated pair of (subject, object, verb) as the keyword. For example, in case of (child, bicycle, like), ‘child’ and ‘bicycle’ may be the keyword.

After completing the analysis as described above for the sentences included in the plurality of web pages (S770), the processor 120 may obtain a web page that contains more than a predetermined number of keywords (S780). The processor 120 may further classify the evaluation information provided from the web pages into positive evaluation information and negative evaluation information on the product.

The processor 120 may determine a sentence including the most searched keyword on the web page as the evaluation information. In addition, the processor 120 may determine a predetermined number of evaluation information having a high score among the evaluation information as the positive evaluation information, and determine a predetermined number of evaluation information having a low score as the negative evaluation information.

In addition, the processor 120 may transmit the positive evaluation information and the negative evaluation information to the external electronic apparatus 200.

In case that the searched web page includes a plurality of shopping mall web pages and a rating for the item exists in each shopping mall web page, the processor 120 may average the ratings for the item displayed on the shopping mall web page.

To this end, the processor 120 may use the learned artificial intelligence model. For example, in order to determine whether numerical information displayed on the shopping mall web page is the rating or simply numerical information, the electronic apparatus 100 may use the learned artificial intelligence model.

In addition, the electronic apparatus 100 may determine the numerical information displayed next to a text indicating the evaluation such as ‘rating’ and ‘evaluation score’ as a rating for the item. Meanwhile, this is merely one example, and the electronic apparatus 100 may also determine the numerical information displayed next to the figures such as star, facial expression emoticons, etc. as the rating for the item.

Meanwhile, the processor 120 may also transmit additional information to the external electronic apparatus 200 together with the positive and negative evaluation information.

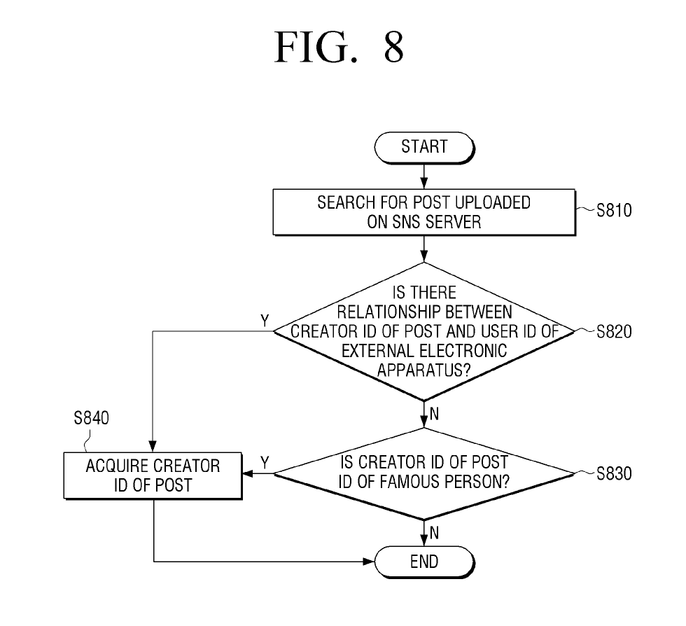

FIG. 8 is a flowchart illustrating an example process of obtaining additional information according to an embodiment of the disclosure. For example, FIG. 8 is a diagram for describing a process of obtaining information on a user using an item corresponding to a search word among users of the SNS to which the user of the external electronic apparatus 200 subscribes.

The electronic apparatus 100 may search a web page including a post uploaded to an SNS server among the web pages including the search word (S810).

The processor 120 may determine creator ID of an article or image posted on the searched web page.

In addition, the processor 120 may determine whether there is a relationship between the creator ID of the post and the user ID of the external electronic apparatus 200 (S820).

For example, the processor 120 may receive SNS information of the user of the external electronic apparatus 200 from the external electronic apparatus 200. The SNS information of the user may include an SNS web address, SNS ID, a password of the SNS, and the like.

In addition, the processor 120 may receive an open application program interface (API) from the server of the SNS to which the user of the external electronic apparatus 200 subscribes. The open API may refer, for example, to an application program interface that is opened so as to be used by everyone.

The processor 120 may obtain the SNS ID having a predetermined relationship with the user ID of the external electronic apparatus 200 using the open API of the SNS corresponding to the searched web page, and may determine whether there is a relationship between the creator ID of the post and the user ID of the external electronic apparatus 200 using the obtained SNS ID information.

The relationship between the creator ID and the user ID is a relationship online, and may mean a relationship in which the creator ID and the user ID are friends online, or one ID of the creator ID and the user ID follows another ID. Meanwhile, the relationship between the creator ID and the user ID is not necessarily limited thereto, but may also be determined differently depending on a system of the SNS.

The processor 120 may search for the post uploaded to a server providing a SNS by a user who has a relationship with the user of the external electronic apparatus 200 in the SNS among the web pages related to the item, and may obtain information on the user who creates the searched post. Here, the information on the user may include ID of the user who creates the searched post.

The processor 120 may identify whether or not the creator ID of the searched post is included in the SNS ID information having the relationship with the user ID online.

Meanwhile, in case that there is no longer the user having the relationship with the user of the external electronic apparatus 200 in the SNS, the processor 120 may identify whether there is an article written by a famous person among articles related to the item corresponding to the search word (S830).

The famous person may refer, for example, to a person who is widely known offline or online. People who are widely known offline may include broadcasters, entertainers, and politicians. Peoples who are widely known online may include a power blogger, and the like.

To this end, the electronic apparatus 100 may store SNS ID information of the famous persons in the storage (not illustrated). Alternatively, the processor 120 may determine the creator ID of the article posted on the searched web page, and determine the creator ID as the ID of the famous person in case that the number of IDs having a predetermined relationship with the creator ID is large.

In case that the creator ID of the searched post is an ID having a relationship with the user of the external electronic apparatus 200 online or the ID of the famous person, the processor 120 may obtain the information on the creator (S840). Here, the information on the creator may include the SNS ID or name of the user and the SNS ID or name of the famous person who have the relationship with the user of the external electronic apparatus on the SNS.

In addition, the processor 120 may transmit the information on the user who creates the searched post to the external electronic apparatus 200.

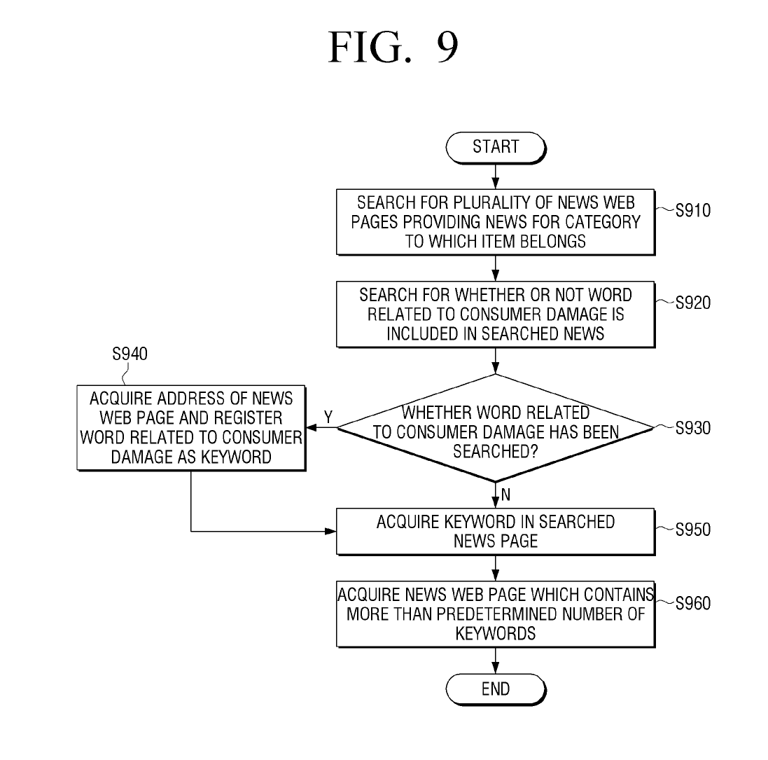

FIG. 9 is a flowchart illustrating an example process of obtaining additional information according to an embodiment of the disclosure. For example, FIG. 9 describes a process of obtaining information on a news web page including a specific word among news web pages for a category to which an item corresponding to a search word belongs.

The processor 120 may search for a plurality of news web pages providing news about the category to which the item belongs (S910).

In addition, the processor 120 may obtain the news web page including the specific word among the plurality of news web pages through an artificial intelligence model learned to determine whether or not the specific word is included.

The specific word may, for example, be a word (hereinafter, referred to as ‘consumer damage related word’) indicating damage that may occur to a consumer using at least one item belonging to the same category as the category to which the item corresponding to the search word belongs. For example, in case that the search word is “OO Car”, the category of the car may be a vehicle, traffic, and the like, and the consumer damage related word (e.g., sudden unintended acceleration, recall, defect, etc.) that may occur in the category such as the car or the traffic may be the specific word.

The processor 120 may search for whether or not a word related to the consumer damage related word in the web page searched in step S910 is included in the searched news (S920).

A deep learning module may be used by the processor 120 to search for the consumer damage related word. The electronic apparatus 100 may perform learning about the consumer damage related word using the deep learning module. For example, the electronic apparatus 100 may perform learning about consumer damage related news including words such as accident, damage, explosion, carcinogen, sudden unintended acceleration, food poisoning, and the like.

In case that it is determined that the consumer damage related word is included in the searched web page (S930), the processor 120 may obtain an address of the corresponding news web page and determine the searched consumer damage related word as the keyword (S940).

The processor 120 may also determine that the consumer damage related word is not included in the searched web page. In this case, the processor 120 may obtain a keyword related to the item to obtain news web page information related to the item.

The processor 120 may analyze a sentence included in the searched news web page and obtain the keyword (S950). A process of analyzing the sentence and the determining the keyword is similar to the process described in FIG. 7. That is, the processor 120 may separate the sentence included in the news web page using the natural language processing module, and obtain the pair of (subject, object, verb) in the respective sentences to determine the word corresponding to the subject and the object as the keywords.

The processor 120 may obtain the news web page which contains more than predetermined number of keywords (S960).

For example, in case that the searched web page news is the consumer damage related news, it is highly likely that the consumer damage related word is set as the keyword and is included more than predetermined times in the plurality of web pages. Therefore, the processor 120 may obtain consumer damage related news web page information as the additional information.

Even in a case where there is no consumer damage related news in the searched web page news, the processor 120 may obtain news web page information which contains more than predetermined number of keywords, and this may be a web page most relevant to the item.

As described above, after obtaining the information on the news web page, the processor 120 may transmit the obtained information on the news web page to the external electronic apparatus 200.

The external electronic apparatus 200 receiving the evaluation information of FIG. 7 and the additional information of FIGS. 8 and 9 from the electronic apparatus 100 may display the received evaluation information and additional information on the display 220.

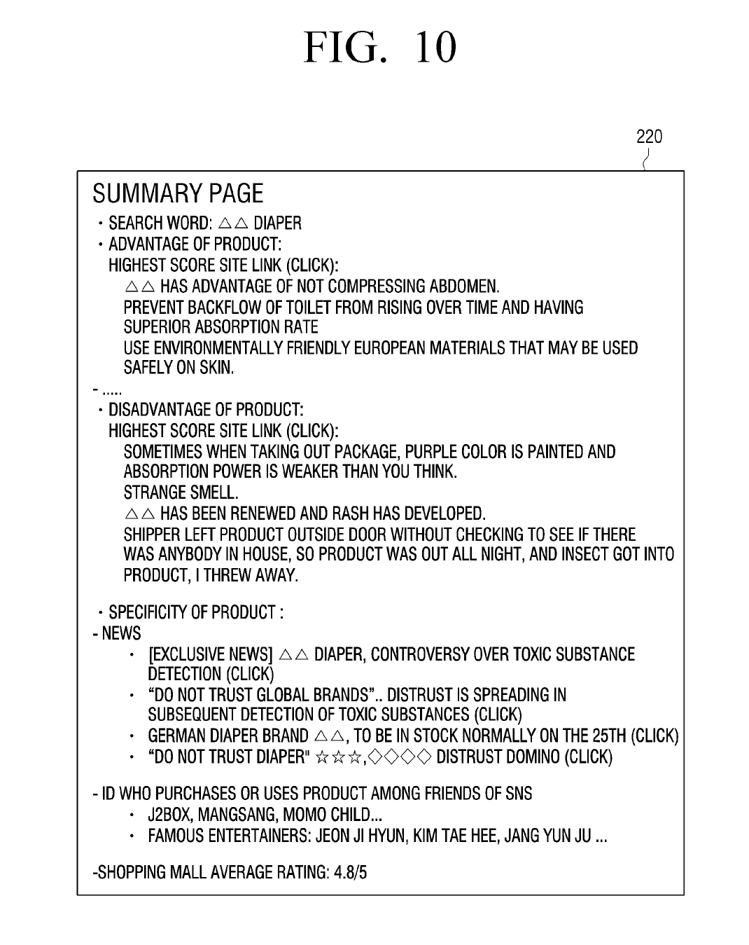

FIG. 10 is a diagram illustrating example evaluation information and additional information displayed on the external electronic apparatus 200 according to an embodiment of the disclosure. FIG. 10 is a summary page of the evaluation information and the additional information displayed on the display 220 of the external electronic apparatus 200.

The external electronic apparatus 200 may receive the evaluation information and the additional information from the electronic apparatus 100, and display, on the display 220, at least one of the search word or the evaluation information and the additional information received for the search word.

The external electronic apparatus 200 may display the summary page of the received evaluation information and additional information so that the user may view the evaluation information and the additional information at a glance.

The external electronic apparatus 200 may classify the evaluation information into positive evaluation information and negative evaluation information.

The external electronic apparatus 200 may display a link for each evaluation information. However, this is merely an example, and instead of displaying the link, the displayed evaluation information may be connected to the web page so that the web page including the corresponding evaluation information is displayed when the user selects the evaluation information.

The external electronic apparatus 200 may display a news title of the news web page including the specific word of the news web page for the category to which the item belongs.

Even in this case, the link for each news web page may be displayed. Instead of displaying the link, the displayed news title may also be connected to the corresponding news web page so that the web page including the corresponding news is displayed when the user selects the news title.

The external electronic apparatus 200 may also display information on the user using the item among the users of the SNS to which the user subscribes. The information on the user may include an ID and a name, and may include a mail address, a telephone number, and the like in some cases.

In case that the user using the item is a user having a relationship with the user of the external electronic apparatus 200 in the SNS, the SNS ID of the user using the item may be displayed on the external electronic apparatus 200. When the displayed SNS ID is selected, the mail address, the telephone number, or the like of the user of the corresponding ID may be displayed, and the user of the external electronic apparatus 200 may obtain information on the item from the user using the item by mail, message, or telephone to the user of the corresponding ID.

In addition, in case that the user using the item corresponds to a famous person, the external electronic apparatus 200 may also display a name of the famous person.

The external electronic apparatus 200 may display a shopping mall rating average for the item. The shopping mall rating average means an average of the scores of the item evaluated in each of the plurality of shopping malls selling the item.

After the electronic apparatus 100 transmits the evaluation information and the addition information on the search word to the external electronic apparatus 200, and the external electronic apparatus 200 displays the evaluation information and the additional information, the evaluation information and the additional information on the item may be added on the web page.

In order to display the added evaluation information and additional information on the external electronic apparatus 200, the electronic apparatus 100 may re-search for the evaluation information and the additional information added after the last search and transmit it to the external electronic apparatus 200.

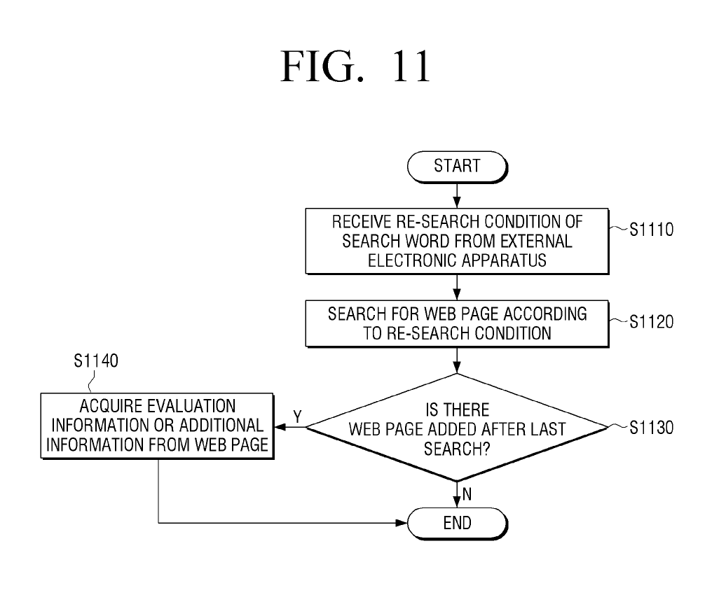

FIG. 11 is a flowchart for illustrating an example process of obtaining the added evaluation information or additional information by the electronic apparatus according to an embodiment of the disclosure.

After transmitting the evaluation information and the additional information on the search word to the external electronic apparatus 200, the electronic apparatus 100 may receive a re-search condition for the search word from the external electronic apparatus 200 (S1110). Meanwhile, this is merely one example, and the user may initially input the search word while simultaneously inputting the re-search condition.

The electronic apparatus 100 may store the received re-search condition in the storage (not illustrated).

The re-search condition may include a time, a cycle, and a period for performing the re-search, or a number of times of re-search after transmitting the evaluation information and the additional information to the external electronic apparatus 200.

The electronic apparatus 100 may search for the web page according to the re-search condition (S1120). For example, the electronic apparatus 100 may perform re-search for the search word after a predetermined time elapses after transmitting the evaluation information and the additional information to the external electronic apparatus 200.

The electronic apparatus 100 may determine whether there is a web page added to the search word after the last search (S1130). To this end, the electronic apparatus 100 may determine whether there is a web page added during the time between the last search and the re-search using information on the time in which the last search is performed. Meanwhile, this is merely one example, and the added web page is not necessarily determined by the above-mentioned method.

In case that there is a web page added after the last search, the electronic apparatus 100 may obtain the evaluation information or the additional information from the added web page (S1140). A process of obtaining the evaluation information and the additional information is the same as that described in FIGS. 7 to 9, and a description thereof is thus omitted.

The electronic apparatus 100 may transmit the evaluation information or the additional information obtained by performing the re-search to the external electronic apparatus 200.

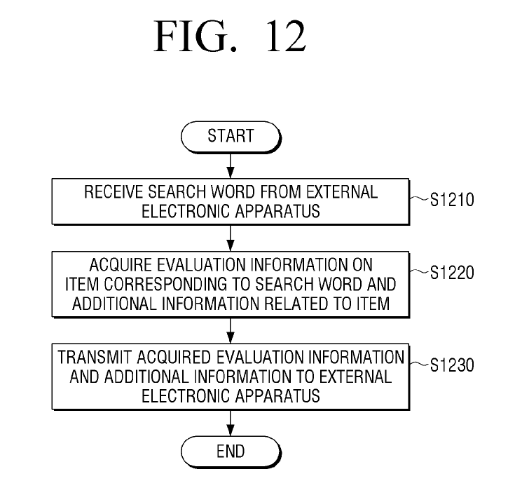

FIG. 12 is a flowchart illustrating an example method of controlling an electronic apparatus according to an embodiment of the disclosure.

The electronic apparatus 100 may receive a search word from the external electronic apparatus 200 (S1210).

In addition, the electronic apparatus 100 obtains evaluation information on an item corresponding to the search word and additional information related to the item (S1220).

The additional information includes at least one of information on a news web page including a specific word among news web pages for a category to which the item belongs and information on a user who uses the item among the users of the SNS to which the user of the external electronic apparatus subscribes.

Thereafter, the electronic apparatus 100 may transmit the obtained evaluation information and additional information to the external electronic apparatus 200 (S1230).

The operation of obtaining the evaluation information may include an operation of classifying the evaluation information provided from the web page into positive evaluation information and negative evaluation information on the item by analyzing the web page providing the evaluation information on the item through the learned artificial intelligence model to classify the evaluation information into the positive evaluation information and the negative evaluation information. In addition, the operation of transmitting the evaluation information to the external electronic apparatus may include an operation of transmitting the positive evaluation information and the negative evaluation information to the external electronic apparatus.

In addition, the operation of obtaining the additional information may include an operation of searching for a plurality of news web pages providing news for a category to which the item belongs, and an operation of obtaining a news web page including a specific word among the plurality of news web pages through the learned artificial intelligence model to determine whether or not the specific word is included.

The specific word may be a word indicating damage that may occur to a consumer using at least one item belonging to the same category as the category to which the item belongs.

Meanwhile, the operation of obtaining the additional information may include an operation of searching for a post uploaded to a server providing an SNS by a user who has a relationship with the user of the external electronic apparatus 200 in the SNS among the web pages related to the item and obtaining information on the user who creates the searched post.

The information on the user may include ID of the user who creates the searched post.

The various example embodiments described above may be implemented in a recording medium that is readable by a computer or a device similar to the computer using software, hardware, or any combination thereof.

With hardware implementation, the embodiments described in the disclosure may be implemented using, for example, and without limitation, at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electrical units, or the like for performing other functions. In some cases, the embodiments described in the disclosure may be implemented by the processor 120 itself.

With software implementation, embodiments such as procedures and functions described in the specification may be implemented as separate software modules. Each of the software modules may perform one or more functions and operations described in the specification.

Computer instructions for performing a processing operation in the electronic apparatus according to the various example embodiments of the disclosure described above may be stored in a non-transitory computer-readable recording medium. The computer instructions stored in the non-transitory computer-readable medium cause the specific device described above to perform the processing operations in the electronic apparatus according to the various example embodiments described above when executed by a processor of the specific device.

The non-transitory computer-readable recording medium may refer, for example, to a machine readable medium that semi-permanently stores the data. For example, the non-transitory computer-readable medium may, for example, and without limitation, be a CD, a DVD, a hard disc, a Blu-ray disc, a USB, a memory card, a ROM, or the like.

Although various example embodiments of the disclosure have been illustrated and described, it should be understood that the disclosure is not limited to the disclosed embodiments and may be variously changed without departing from the spirit and the scope of the disclosure. Therefore, the disclosure should be understood as including all the changes, equivalents, and substitutions included in the spirit and scope of the disclosure.

What is claimed is:

1. An electronic apparatus comprising:
a communicator comprising communication circuitry; and
a processor configured to:
obtain evaluation information on an item corresponding to a search word and additional information related to the item based on the search word received from an external electronic apparatus through the communicator, and
control the communicator to transmit the obtained evaluation information and additional information to the external electronic apparatus through the communicator,
wherein the additional information includes at least one of:
information on a news web page including a specific word among news web pages for a category to which the item belongs, and
information on a user using the item among users of a social network service (SNS) to which a user of the external electronic apparatus subscribes.

2. The electronic apparatus as claimed in claim 1, wherein the processor is configured to:
classify evaluation information provided from a web page into positive evaluation information and negative evaluation information on the item by analyzing the web page providing the evaluation information on the item through a learned artificial intelligence model to classify the evaluation information into the positive evaluation information and the negative evaluation information, and
control the communicator to transmit the positive evaluation information and the negative evaluation information to the external electronic apparatus.

3. The electronic apparatus as claimed in claim 1, wherein the processor is configured to:
search for a plurality of news web pages providing news for the category to which the item belongs,
obtain a news web page including the specific word from among the plurality of news web pages through a learned artificial intelligence model to identify whether the specific word is included, and
control the communicator to transmit information on the obtained news web page to the external electronic apparatus.

4. The electronic apparatus as claimed in claim 1, wherein the specific word includes a word indicating damage that occurs to a consumer using at least one item belonging to the same category as the category to which the item belongs.

5. The electronic apparatus as claimed in claim 1, wherein the processor is configured to:
search for a post uploaded to a server providing the SNS by a user having a relationship with the user of the external electronic apparatus in the SNS in the web page related to the item, and
obtain information on a user who created the searched post.

6. The electronic apparatus as claimed in claim 5, wherein the information on the user includes identification (ID) of the user who created the searched post.

7. A method of controlling an electronic apparatus, the method comprising:
receiving a search word from an external electronic apparatus;
obtaining evaluation information on an item corresponding to the search word and additional information related to the item; and
transmitting the obtained evaluation information and additional information to the external electronic apparatus,
wherein the additional information includes at least one of:
information on a news web page including a specific word among news web pages for a category to which the item belongs, and
information on a user using the item among users of a social network service (SNS) to which a user of the external electronic apparatus subscribes.

8. The method as claimed in claim 7, wherein the obtaining of the evaluation information includes classifying evaluation information provided from a web page into positive evaluation information and negative evaluation information on the item by analyzing the web page providing the evaluation information on the item through a learned artificial intelligence model to classify the evaluation information into the positive evaluation information and the negative evaluation information, and
wherein the transmitting of the evaluation information to the external electronic apparatus includes transmitting the positive evaluation information and the negative evaluation information to the external electronic apparatus.

9. The method as claimed in claim 7, wherein the obtaining of the additional information includes:
searching for a plurality of news web pages providing news for the category to which the item belongs, and
obtaining a news web page including the specific word from among the plurality of news web pages through a learned artificial intelligence model to identify whether the specific word is included.

10. The method as claimed in claim 7, wherein the specific word includes a word indicating damage that occurs to a consumer using at least one item belonging to the same category as the category to which the item belongs.

11. The method as claimed in claim 7, wherein the obtaining of the additional information includes:
searching for a post uploaded to a server providing the SNS by a user having a relationship with the user of the external electronic apparatus in the SNS in the web page related to the item, and
obtaining information on a user who created the searched post.

12. The method as claimed in claim 11, wherein the information on the user includes identification (ID) of the user who created the searched post.
